(19) United States
(12) Patent Application Publication
(10) Pub. No.: US 2024/0095759 A1
(43) Pub. Date: Mar. 21, 2024

(54) SYSTEM, METHOD, AND COMPUTER PROGRAM FOR SOCIAL PLATFORM INFORMATION PROCESSING

(71) Applicant: RAKUTEN MOBILE, INC., Tokyo (JP)

(72) Inventors: Tomoya MURATA, Tokyo (JP); Rina TAKAMATSU, Tokyo (JP); Bal Vikas NIRALA, Delhi (IN)

(73) Assignee: RAKUTEN MOBILE, INC., Tokyo (JP)

(21) Appl. No.: 18/014,051

(22) PCT Filed: Feb. 23, 2022
(86) PCT No.: PCT/US2022/017413

§ 371 Date: Dec. 30, 2022

(51) Int. Cl. G06Q 30/0201; G06Q 50/00

(52) U.S. Cl. CPC G06Q 30/0201; G06Q 50/01

(57) ABSTRACT

A method for processing information from a social platform and triggering an action such as creating a ticket is provided. The method includes monitoring information on a social platform, based on predetermined keywords set by a system user, extracting information related to a service from the social platform, the extracted information containing of the predetermined keywords, and determining a sentiment value associated with the extracted information, assigning the extracted information to a sentiment category based on the sentiment value. The sentiment category being one of a positive sentiment category, a negative sentiment category, or a neutral sentiment category. The method further including generating a graphical user interface (GUI) displayed to the system user for displaying the ticket to the system user. Using the GUI, the system user inputs information, based on the extracted information and the assigned sentiment category, to generate a ticket.

### BACKGROUND

### Field

The disclosure relates generally to monitoring information on a social platform for keywords and/or phrases that may be extracted and processed. The processing may trigger an action such as notifying a system user, sending a direct message to an end user, and/or creating a ticket.

### Description of Related Art

Information (e.g., comments, posts, live feeds, etc.) on social platforms are important insight for determining user's response on a specific matter (e.g., satisfaction on a product, urgency on an issue, interest in a new service, etc.). Conventionally, service providers/product manufacturers hire analysts to manually monitor potential problematic information on the social platforms. The role of the analyst is to monitor the information on social platforms, analyze the information, and determine whether or not there is any information that would bring negative impact (e.g., damage in branding, loss of customers, etc.) on the service providers/product manufacturers. If potential problematic information is detected, the analysts need to manually review the issue to extract key information, create a ticket for the issue based on the key information, wait for the ticket to be reviewed and assigned to appropriate personnel, and connect the end user who raises the problematic information to personnel in charge. This system of analyzing information is costly, time consuming, and not standardized.

### SUMMARY

One or more example embodiments of the present disclosure provide a system and method for monitoring information (e.g., comments/posts/live feeds) on a social platform, extracting the information from the social platform according to a user's predetermined conditions, processing the extracted information, and performing an action based on results of the processing. For example, the action may include posting a reply and/or comment on the comments/posts/live feeds, send a direct message to the end user, automatically creating a ticket to be assigned or handled by a system user. The action is not limited to this and may include other actions not explicitly mentioned herein.

According to embodiments, a method for processing information from a social platform is provided. The method may include monitoring information on a social platform based on predetermined keywords set by the system user, extracting information related to a service from the social platform, the extracted information containing one or more of the predetermined keywords, determining a sentiment value associated with the extracted information, assigning the extracted information to a sentiment category, and generating a graphical user interface (GUI) displayed to the system user, wherein the system user inputs information, based on the extracted information and the assigned sentiment category, to generate a ticket. The sentiment category may be one of a positive sentiment category, a negative sentiment category, or a neutral sentiment category, based on the sentiment value.

According to embodiments, a system for processing information from a social platform is provided. The system may include one or more memory storing instructions and one or more processors configured to execute the instructions to monitor information on a social platform based predetermined keywords set by the system user, extract information related to a service from the social platform, the extracted information containing one or more of the predetermined keywords, determine a sentiment value associated with the extracted information, assign the extracted information to a sentiment category, and generating a GUI displayed to the system user, wherein the system user inputs information, based on the extracted information and the assigned sentiment category, to generate a ticket. The sentiment category may be one of a positive sentiment category, a negative sentiment category, or a neutral sentiment category, based on the sentiment value.

According to embodiments, a non-transitory computer-readable storage medium for processing information from a social platform is provided. The storage medium may be connected to one or more processors and may be configured to store instructions that, when executed, cause the at least one or more processors to monitor information on a social platform based on predetermined keywords set by a system user, extract information related to a service from the social platform, the extracted information containing one or more of the predetermined keywords, determine a sentiment value associated with the extracted information, assign the extracted information to a sentiment category, and generating a GUI displayed to the system user, wherein the system user inputs information, based on the extracted information and the assigned sentiment category, to generate a ticket. The sentiment category may be one of a positive sentiment category, a negative sentiment category, or a neutral sentiment category, based on the sentiment value.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the following accompanying drawings.

FIG. 1 is a diagram of devices of a system according to one or more embodiments.

FIG. 2 is a diagram of components of the devices of FIG. 1 according to one or more embodiments.

FIG. 3 is an exemplary diagram of a centralized customer supporting system according to one or more embodiments.

FIG. 4 is an exemplary flowchart illustrating a method for processing information from a social platform according to one or more embodiments.

FIG. 5 is an example block diagram illustrating a system for processing information from a social platform according to one or more embodiments.

FIG. 6 is a diagram illustrating an example of a graphical user interface (GUI) according to one or more embodiments.

FIG. 7 is a diagram illustrating another example GUI according to one or more embodiments.

FIG. 8 is a diagram illustrating another example GUI according to one or more embodiments.

FIG. 9 is a diagram illustrating another example GUI according to one or more embodiments.

FIG. 10 is a diagram illustrating another example GUI according to one or more embodiments.

FIG. 11 is a diagram illustrating another example GUI according to one or more embodiments.

### DETAILED DESCRIPTION

The present disclosure relates to a centralized information processing system that monitors social platform information, automatically determines potential problematic information and creates a ticket therefrom, and allows a service provider to quickly send a direct message/reply to an end user thereafter.

Related art approaches to monitoring and responding to social media platform posts have several shortcomings. First, related art approaches have difficulty in establishing a standard way of determining what constitutes problematic information. The determination of whether or not an item of information (e.g., post, feedback, review, etc.) may be problematic is based on the decision of an analyst. One analyst may think a particular item or piece of information is problematic, while other analysts may decide that the same piece of information is non-problematic. A non-standardized method for creating a ticket only causes further inconsistencies in results. The ticket is created based on the information extracted by the analyst, and different analysts may extract different information for creating the ticket. Accordingly, this will delay ticket management (e.g., review ticket, assign ticket handler, etc.) and contribute to a delay in overall response time including a late response to the end user who raises an urgent or time sensitive issue which may require immediate attention. The monitoring process is also performed manually by the analyst, and it is burdensome for the analyst to monitor all possible information on a social media platform, let alone multiple social media platforms. The analyst is also prone to human error and may overlook some important information. Further, it may be costly to hire an analyst to monitor the information from the social platform.

In view of the above, there is a need to provide a system which can automatically monitor the social platform information, automatically determine potential problematic information and create a ticket therefrom, and allow the service provider to quickly send a direct message/reply to the end user. This disclosure provides such an advantageous system to improve upon the above described approaches.

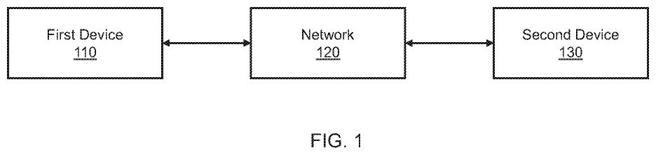

FIG. 1 is a diagram of a system according to an embodiment. FIG. 1 includes a first device 110, a network 120, and a second device 130. The first device 110 and the second device 130 may interconnect via wired connections, wireless connections, or a combination of wired and wireless connections.

The first device 110 may include user devices such as a computing device (e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device.

The second device 130 may include one or more devices. For example, the second device 130 may be a server device, a computing device, or the like.

The network 120 may include one or more wired and/or wireless networks. For example, network 120 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

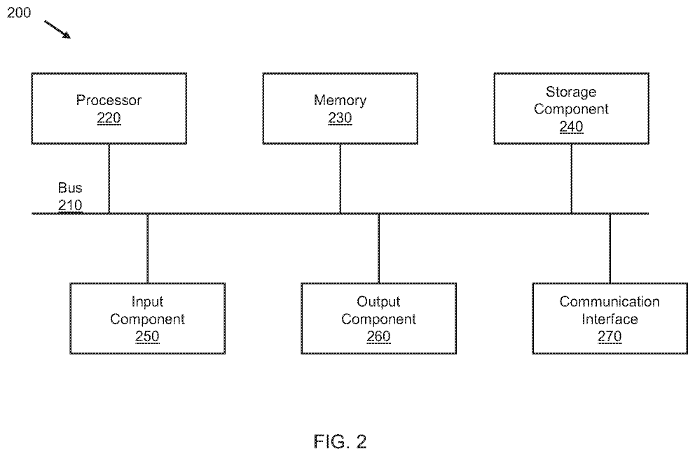

FIG. 2 is a diagram of components of one or more devices of FIG. 1 according to an embodiment. Device 200 may correspond to the first device 110 and/or the second device 130.

As shown in FIG. 2, the device 200 may include a bus 210, a processor 220, a memory 230, a storage component 240, an input component 250, an output component 260, and a communication interface 270.

The bus 210 may include a component that permits communication among the components of the device 200. The processor 220 may be implemented in hardware, software, or a combination of hardware and software. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 220 may include one or more processors capable of being programmed to perform a function.

The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone). The input component 250 may include a sensor for sensing information (e.g., a global positioning system (GPS) component, an accelerometer, a gyroscope, and/or an actuator).

The output component 260 may include a component that provides output information from the device 200 (e.g., a display, a speaker, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

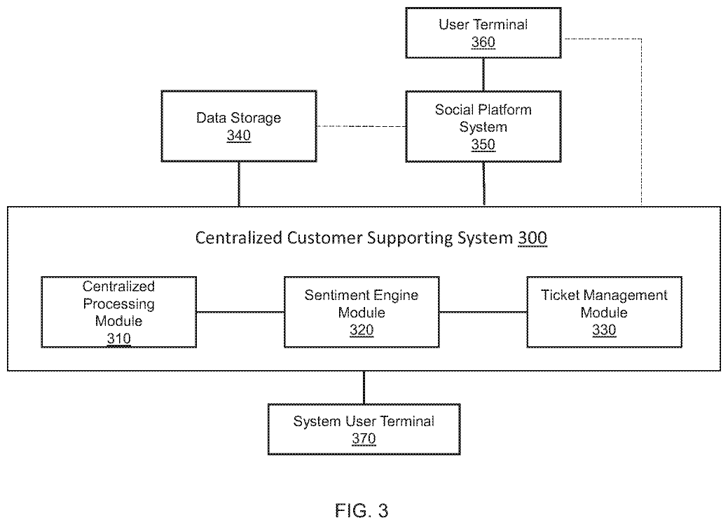

FIG. 3 is an exemplary diagram of a centralized customer supporting system 300 according to an embodiment. The centralized customer supporting system (“the centralized system” hereinafter) 300 may include a centralized processing module 310, a sentiment engine module 320, and a ticket management module 330. The centralized system 300 may also include or be communicably connected to a data storage 340. Further, the centralized system 300 is communicably connected to a social platform system 350, e.g., via a network such as the Internet. The centralized system 300 may correspond to the second device 130 (or one or more server devices) shown in FIG. 1, and the modules may be implemented as software instructions executed by at least one processor 220.

The centralized processing module 310 continuously (or periodically) monitors the information available on a social platform and determines which information is of interest. For example, the centralized processing module 310 may continuously or periodically search or monitor at least one of a particular page or section of the social platform (e.g., one or more pages, sites corresponding to a service provider or entity to which the centralized system 300 belongs or in-charge of monitoring, etc.), one or more predetermined keywords (e.g., a name of the service provider or entity, nicknames for the entity, a field/category of service related to the service provider or entity, etc.), one or more predetermined mentions (e.g., account belonging to the service provider or entity), one or more hashtag keywords, etc. The centralized processing module 310 then extracts the related information from the social platform (e.g., the post, comment, review, etc.). The social platform may be included in or deployed by the social platform system 350 including one or more social platforms. The extracted information is provided to the sentiment engine module 320. The sentiment engine module 320 processes the extracted information to determine (e.g., via a keyword matching method) a sentiment value associated with the extracted information. The sentiment value may represent a sentiment category in which the information falls under. That is, the sentiment engine module 320 may determine whether the information is recognized as a positive, a negative, or a neutral sentiment and then categorizes the information as such. If the information is categorized as a negative sentiment, the information will be provided to the ticket management module 330 for creating an appropriate ticket to be handled by a system user.

The system user may also interact with the end user through a system user terminal 370 via the centralized system 300. The system user may be, for example, an administrator of the service provider, a person in charge of the service associated to the information from the social platform, a customer service agent, or the like. The end user may receive and respond to commination from the system user through a user terminal 360 via the social platform system 350. The system user terminal 370 and the user terminal 360 may correspond to, for example, the first device 110 and/or the second device 130 illustrated in FIG. 1 or device 200 illustrated in FIG. 2. The communication between the system user terminal 370 and the user terminal 360 may be, for example, via direct messaging, reply/comment to a post, etc.

The data from the centralized system 300 (i.e., the extracted information from the centralized processing module 310, the sentiment value from the sentiment engine module 320, and the sentiment category the information falls under) may be stored in the data storage 340. The data storage 340 may be internal or external to the centralized system 300 and may be similar to or different from the storage component 240 of FIG. 2. In some embodiments, data storage 340 comprises multiple data storages.

The centralized processing module 310 is communicatively coupled to the sentiment engine module 320 and the ticket management system module 330, for example, via an API gateway. It is understood, however, that one or more other embodiments are not limited to this configuration. Some modules may be combined or separated into separate modules. For example, the centralized processing module 310 may function as both the centralized module 310 and as the sentiment engine module 320. The centralized system 300 may be communicatively coupled to one or more system user terminals (e.g., system user terminal 370) and may be communicatively coupled to one or more user terminals (e.g., user terminal 360). Further, the centralized system 300 may also be communicatively coupled to the social platform system 350. The social platform system 350 may be communicatively coupled to one or more user terminals (e.g., user terminal 360). The data storage 340 may also be communicatively coupled to the centralized system 300 and the social platform system 350.

The following is a detailed description of an exemplary process of the centralized system 300 of FIG. 3, according to one or more embodiments.

The system user, for example, accesses the centralized system 300 via the system user terminal 370. The system user sets, via the centralized system 300, a predefined keyword(s) that the system user wants to monitor the social platform for. Additionally or alternatively, the system user may also set predefined keyword(s) that are to be excluded from the monitoring. The configuration of the predefined keyword(s) set by the system user is stored in the data storage 340 in a keyword configuration profile. The system user is able to select one or more keyword configuration profiles for monitoring the social platform on, for example, a keyword setting GUI. Based on the selected one or more keyword configuration profiles, the centralized processing module 310 continuously or periodically monitors the information (e.g., post, live feed, comments, etc.) available on the social platform system 350 and determines whether or not the monitored information contains any information that may be related to the predefined keyword(s).

It is understood that one or more other embodiments are not limited to the above-described monitoring process. In another example embodiment, the system user may also set, via the centralized system 300, a predefined location that the system user wants to monitor (or exclude from monitoring) the social platform for. For example, the location may be where the post was made, where the end user is determined to be located (via location data from the social platform system 350), or keyword(s) indicating location (e.g. one of various locations of the service which may include city, state, and/or province name, etc.).

The end user accesses the social platform system 350 via a user terminal 360 and posts information on one or more of the social platforms included in the social platform system 350. The centralized processing module 310 monitors the information on the one or more social platform and determines if the information posted by the end user contains information that is related to the predefined keyword(s). If the information posted by the end user does contain information that is related to the predefined keyword(s), the information is extracted from the social platform. Specifically, the centralized processing module 310 extracts texts from the monitored information (e.g., extract text directly from comments, convert video/audio feed to text description file and extract the text therefrom, etc.) and compares the extracted texts to the predefined keyword(s) in the selected keyword configuration profile(s). The centralized system 300 may be monitoring and extracting the information from text (e.g. posts/comments) as described above, but is not limited thereto. In another example embodiment, the centralized system 300 may monitor and extract information in audio and/or video from the social platform. Audio from the audio/video may be converted into text and monitored for the predefined keyword(s). Alternatively, audio/video determined to contain the predefined keyword(s) (e.g., via waveform comparison, etc.) may be converted into text and further processing may be done thereafter.

In some example embodiments, the system monitors and extracts information relating to a service from one or more social media platforms. Further, in one or more embodiments, the extracted information may be required to be exactly the same as the predefined keyword(s). In another example embodiment, a text in the extracted information may only be required to be similar to the predefined keyword(s) and the comparison may be made based on a degree of similarity. For example, “weak connection” is similar to “bad connection”, “expensive” is similar to “not cheap”, etc. The similarity and relationship of the texts and predefined keyword(s) may be defined manually by the system user via the centralized system 300 and/or may be defined automatically by an AI engine (which may be included in or external to centralized system 300) based on an available dictionary.

The extracted information is then provided by the centralized processing module 310 to the sentiment engine module 320. The sentiment engine module 320 processes the extracted information to determine a sentiment value based on one or more keyword configuration files obtained from the data storage 340. The keyword configuration files may be set by the system user at the same time the predefined keyword(s) are set or at a different time and stored in the data storage 340 thereafter, or can be pre-generated by some other user and stored in the data storage 340 beforehand. The keyword configuration files may also be the same, different, or inclusive of the predefined keyword(s) set by the system user. The keyword configuration file may define a plurality of keywords associated with negative sentiments. For example, “bad”, “weak”, “slow”, “expensive”, “disappointed”, “not good”, etc., are keywords associated with negative sentiments and may be referred to as negative keyword(s). The keyword configuration files may also define a plurality of keywords associated with positive sentiments. For example, “good”, “excellent”, “stable”, “fast”, “satisfied”, etc., are keywords associated with positive sentiments and may be referred to as positive keyword(s). Any other words or phrases which fall outside of the scope of the negative sentiments and the positive sentiments may be considered by the sentiment engine module 320 as associated with neutral sentiments.

The sentiment engine module 320 then determines how many negative keyword(s) and/or positive keyword(s) are included in the extracted information or piece of extracted information, and generates a sentiment value. For example, an initial sentiment value is 0. Each of the negative keyword(s) and positive keyword(s) has a respective value, e.g., “bad” has a value of −1, “worst” has a value of −2 (since the degree of the negative sentiment “worst” is higher than the degree of the negative sentiment “bad”), “good” has a value of +1, “best” has a value of +2 (since the degree of the positive sentiment “best” is higher than the degree of the positive sentiment “good”), and the like. The total sentiment value of extracted information (e.g., a post/comment) including keywords “bad” and “worst” will be lower than a post/comment that includes only “bad”. Similarly, a post/comment that comprises “bad” and “best” will have a total sentiment value lower than a post/comment that comprises “best” and “good”. The total sentiment value may be calculated as a summation of the respective sentiment values included in an extracted information (e.g. a post/comment, etc.). In some embodiments, the total sentiment value may be calculated via other mathematical processes, such as a multiplication process or the like.

Accordingly, the sentiment engine module 320 generates a sentiment value that represents the sentiment level of the extracted information or the total sentiment value of the entire information (e.g., the entire post/comment). If the information has a total sentiment value that is negative, the information will be determined as having a negative sentiment. If the information has a total sentiment value that is positive, the information will be determined as having a positive sentiment. If the information has a sentiment value of zero, the system will determine that the information has a neutral sentiment. In some embodiments, if the total sentiment value is below/exceeds a predetermined threshold value (e.g., predetermined by the system user, etc.), the information will be determined as having a negative sentiment, a positive sentiment, or a neutral sentiment. The lower the value of a negative sentiment value, the more negative the information is determined to be (e.g., an information with sentiment value of −10 is determined to be more negative than an information with sentiment value of −1). The higher the value of a positive sentiment value, the more positive the information is determined to be (e.g., an information with sentiment value of +10 is determined to be more positive than an information with sentiment value of +1). In some example embodiments, negative sentiments with a negative sentiment value lower than a predetermined threshold may be determined as requiring urgent attention and/or set as requiring higher priority to the system user as compared to other negative sentiments with a negative value that is not lower than the predetermined threshold. Alternative embodiments or any suitable variation of the above described example embodiment (e.g., a positive sentiment value below a threshold representing a neutral or a negative sentiment, etc.) should not be excluded from the scope of disclosure.

The generated sentiment value is provided by the sentiment engine module 320 to the centralized processing module 310. The centralized processing module 310 then determines whether or not the extracted information falls under the following categories, based on the sentiment value: Positive, Negative, or Neutral sentiment. If it is determined that the extracted information falls under the Negative sentiment category, the centralized processing module 310 may generate a message (e.g., in the form of email, SMS, push notification, etc.) to notify the system user that negative information has been posted on a social platform and investigation of the post is required. The notification is not limited to this and may include other messages and details of the post (e.g., at least one of an identifier of the social platform in the social platform system the user posted the comment on, the keywords found in the comment, the sentiment value determined to be associated with the post, time stamp of the post, other related posts by the same end user that include related information/keywords, etc.). Further, the ticket management module 330 may generate and present, for example, a ticket creation GUI to the system user to allow the system user to create a ticket for the social platform information determined as negative information. Specifically, the ticket creation GUI comprises a plurality of input fields to receive inputs from the system user for specifying the ticket. In some embodiments, the ticket creation GUI includes a graphical representation area (e.g., a list, a post portion, etc.) showing at least a portion of the negative information (e.g., portion which is determined as negative information in a post, etc.) and showing the information required for creating a ticket (e.g., the total sentiment value, the sentiment category of the potential issue, the location of the post, etc.) so as to allow the system user to easily and clearly create a ticket based thereon. In some embodiments, the ticket management module 330 may automatically generate a ticket, in response to the extracted information falling under the Negative sentiment category. The ticket may be generated and presented to the system user on a GUI to enable review and editing via the system user terminal 370.

In some example embodiments, it is possible that multiple tickets are generated at the same time. The multiple tickets may be generated from the same social platform or different social platforms in the social platform system 350. In some embodiments, the ticket management module 330 may generate and present the ticket creation GUI to the system user to allow the system user to create a ticket for the social platform information determined as positive or neutral information. Embodiments of the present disclosure are not limited to automatic generation of a ticket. For example, in another example embodiment, the system user is notified of the extracted information and/or the sentiment category, and the system user manually creates the ticket(s).

The ticket will be assigned by the system user (via the ticket creation GUI) to an appropriate handler. The handler/ticket assignee will then review the ticket and determined whether or not it is required to interact with the end user who raised the issue or made the post/comment. If it is determined that it is required to interact with the end user who raised the information, the system user may communicate with the end user via, for example, a GUI. For example, the system user may use the GUI to send a direct message to the end user, replying to the post/comment, etc.

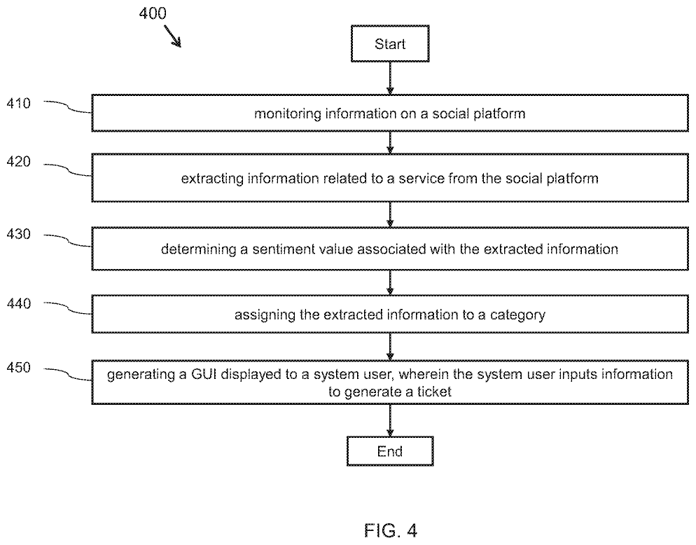

FIG. 4 is an exemplary flowchart illustrating a method 400 for processing information from a social platform, according to an embodiment. The method 400 of FIG. 4 may be performed by the centralized system 300.

Referring to FIG. 4, in operation 410, information on a social platform is monitored. For example, an entirety of the social platform may be monitored, certain search keywords may be monitored, certain hashtags or topics may be monitored, certain account pages may be monitored, etc.

In operation 420, information related to a service or a service provider is extracted from the social platform.

In operation 430, a sentiment value associated with the extracted information is determined based on the extracted information.

In operation 440, a sentiment category is determined or assigned for the extracted information according to the sentiment value.

In operation 450, a GUI is generated and displayed to the system user. Using the GUI, the system user generates a ticket by inputting information, based on the extracted information and the assigned sentiment category.

Although FIG. 4 shows example operations of the method, in some implementations, the method may include additional operations, fewer operations, different operations, or differently arranged operations than those depicted in FIG. 4. Additionally, or alternatively, two or more of the operations of the method may be performed in parallel or combined.

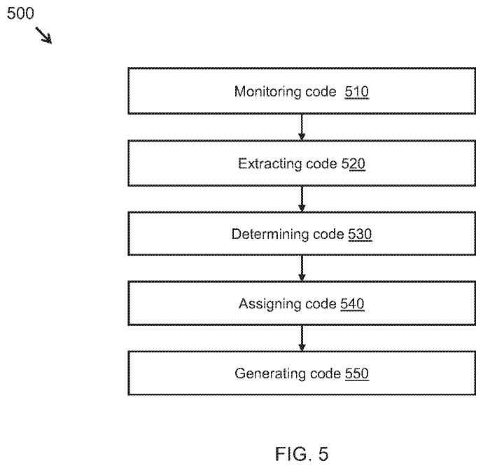

FIG. 5 is an example block diagram illustrating a system 500 for processing information from a social platform according to an embodiment. The system 500 may include at least one memory configured to store computer program code and at least one processor configured to access the computer program code and execute an action as instructed by the computer program code.

As shown in FIG. 5, the computer program code may include monitoring code 510, extracting code 520, determining code 530, assigning code 540, and generating code 550.

The monitoring code 510 is configured to cause the at least one processor to monitor information on a social platform, based for example on a set of predetermined keywords.

The extracting code 520 is configured to cause the at least one processor to extract information related to a service from the social platform, the extracted information containing one or more keywords in the set of predetermined keywords.

The determining code 530 is configured to cause the at least one processor to determine a sentiment value associated with the extracted information.

The assigning code 540 is configured to cause the at least one processor to assign the extracted information to a sentiment category, the sentiment category being one of a positive sentiment category, a negative sentiment category, or a neutral sentiment category, based on the sentiment value.

The generating code 550 is configured to cause the at least one processor to generate a GUI and display the GUI to the system user. Using the GUI, the system user may generates a ticket by inputting information, based on the extracted information and the assigned sentiment category.

Although FIG. 5 shows example code or instructions (in the form of blocks) executed by the system, in some implementations, the system may include additional blocks, fewer blocks, different blocks, or differently arranged blocks than those depicted in FIG. 5. Additionally, or alternatively, two or more of the blocks of the apparatus may be combined.

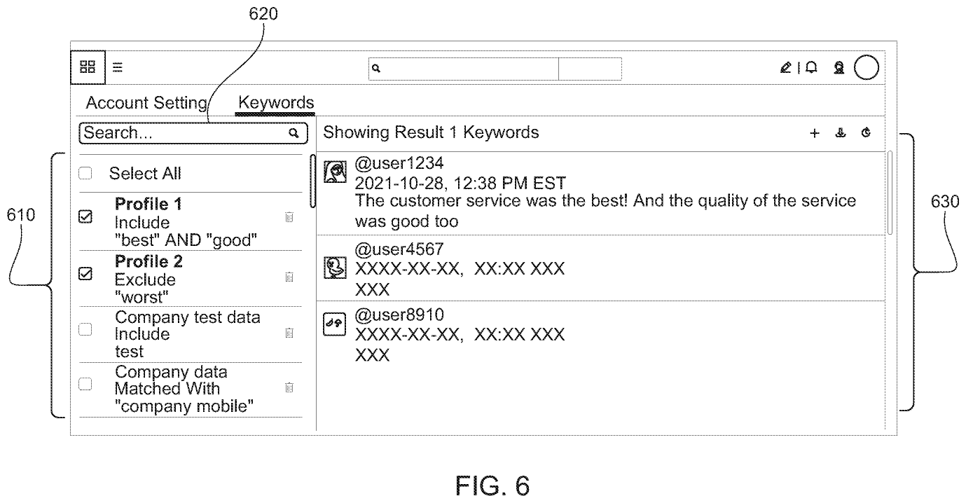

FIG. 6 is an example illustration of a GUI for setting the keyword (hereafter “keyword setting GUI 600”), according to an embodiment.

As shown in FIG. 6, a list 610 of stored or previously set keyword configuration profiles may be displayed on the keyword setting GUI 600. The system user may make a search for a desired keyword configuration profile from the list 610 using an input search field 620. One or more keyword configuration profiles may be searched and selected for monitoring of the social platforms. For example, as shown in FIG. 6, Profile 1 and Profile 2 are selected. Profile 1 is a search criteria for information containing predefined keywords “best” and “good”. Profile 2 is a search criteria for information excluding predefined keyword “worst”. In the example of FIG. 6, the list 610 also includes Profiles 3-4 with predefined keyword search criteria. The system user may also set a new keyword configuration profile to be stored. If a new keyword configuration profile is set, the new keyword configuration profile will then be displayed as an option in the list 610. It is understood that the keyword configuration profiles are not limited to this. A combination of the above described selection options may be used. That is, the system user may select one or more previously set keyword configuration profile from the list 610, and further set and select other new keyword configuration profiles accordingly used to monitor the social platform.

In the same or another embodiment, the system user may also delete an existing or newly set keyword configuration profile. The system user may also select an option to select all the keyword configuration profile in the list 610.

Upon selecting keyword configuration profiles, based on the selected keyword configuration profiles, the centralized system 300 monitors the information on the social platform, determines if the information (i.e., posts/comments) relate to the predefined keyword(s) in the selected keyword configuration profiles, extracts the information determined to relate to the to the predefined keyword(s) in the selected keyword configuration profiles, and displays a list of extracted information 630, as a result of the search, to the system user. For each of the extracted information, the list of extracted information 630 may include a portion of the information (e.g., a portion of a post/comment), the end user's name/username/photo ID, the time and date of the information posted on the social platform, etc. The list of extracted information 630 may be displayed in order of relevance, importance, time/date of post/comment, alphabetical order, etc. In the example of FIG. 6, the list of extracted information 630 includes a post made by @user1234, @user4567, and @user8910 and their corresponding post times, dates, and posts. The system user may choose to select at least one of the extracted information from the list to create a ticket relating thereto.

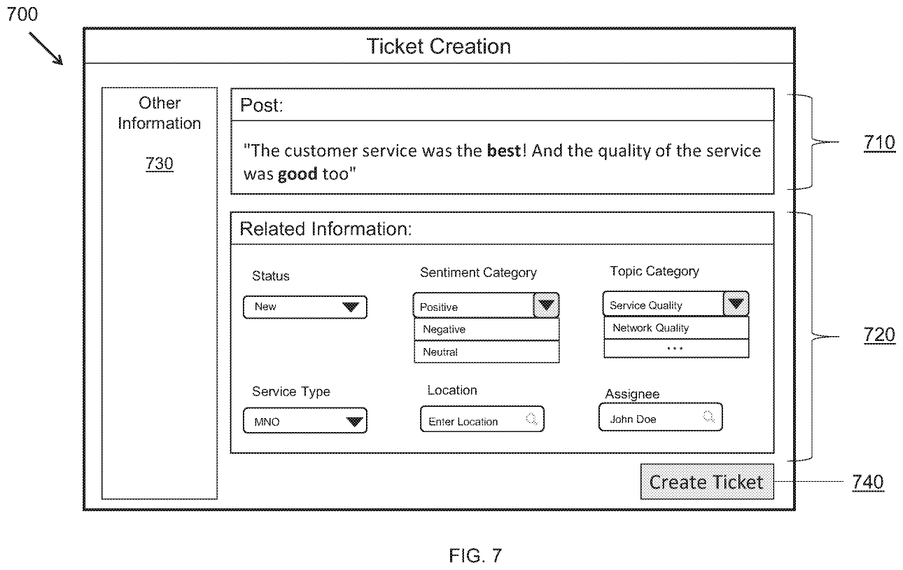

FIG. 7 is a diagram illustrating an example of a GUI for creating the ticket (hereafter “ticket creation GUI 700”), according to an embodiment.

As shown in FIG. 7, the ticket creation GUI 700 may include a dashboard containing information extracted from the social platform and ticket parameters. The dashboard may include information retrieved from the social platform system 350 such as a full post, full comments, and information on the end user such as a user name. For example, the dashboard may include at least the extracted information from the list of extracted information 630. The information or keyword(s) which resulted in the particular sentiment category may also be included or emphasized (e.g., highlighted, bold, underlined, etc.) in the post. The presented information is not limited to the above-described examples, and may include other information. As shown in FIG. 7, ticket creation GUI 700 dashboard includes the end user's post 710. Further, the keyword(s) (e.g. “best” and “good”) are in bold and distinguishable in the extracted post.

The related information section 720 may include a plurality of input windows to allow the system user to view and edit the ticket parameters which may be required for creating a ticket. The parameters may include a status, a sentiment category, a topic category, a service type, a location, and an assignee (i.e. a system user assigned to handle the ticket).

In some embodiments, the topic category is the category of the potential issue being raised in the post/comment. For example, the potential issue may be related to network quality, service quality, etc. It is understandable that the topic category is not limited to potential issue, but can also be any positive or neutral topics (e.g., top customer service, average pricing, etc.) One or more of the topic category, the sentiment category, the status, and the service type input windows may be pre-filled with parameters recommended by the centralized system 300. In the example of FIG. 7, the centralized system 300 determines that the post is related to service quality and the post falls under positive sentiment category, and thus pre-fills the input window of topic category with a parameter of “Service Quality” and pre-fills the input window of sentiment category with a parameter of “Positive”. If the system user, based on analysis of the post 710, determines one or more of the ticket parameters should be changed, the system user may have the authority to change the system recommended parameters by selecting the arrow by/associated with the ticket parameter the system user would like to change. The arrow will display a drop-down menu associated with the respective ticket parameter. An exemplary drop-down menu associated with example selection options for the sentiment category and the topic category ticket parameters are displayed in FIG. 7. Additionally, although FIG. 7 illustrated that the system user is prompted to enter the location, in another embodiment, the location parameter may also be auto filled by the centralized system 300 based on, for example, the extracted information or information from the social platform system 350.

In the example of FIG. 7, the assignee is a user named John Doe. The assignee may be associated with the topic category (e.g., when the topic category is “Service Quality”, the assignee may be a user responsible of handling tasks related to service quality, etc.) The assignee may be the same or different from the system user creating the ticket. The ticket creation GUI 700 may also include a list 730 presenting other information. The other information may be the other posts/comments from the list of extracted information 630. In some example embodiments, the other information may be customized by the system user to include information desired by the system user, and/or configure the presentation of the other information according to keyword(s), regions, user groups, and/or any other suitable factors for categorizing the information.

Based on the information on the ticket creation GUI 700, the system user may trigger the creation of a new ticket by performing a predetermined operation such as clicking on a functional element 740 (e.g., a button, etc.). As shown in FIG. 7, an example of such a function element is labeled “Create Ticket”. Once the ticket is created, the ticket may be stored and presented to the system user in another GUI displaying a list of created tickets. In some example embodiments, the ticket is created by the centralized system 300. In another example embodiment, when the system user triggers the dedicated functional element 740, the centralized system 300 will contact a ticket creation system (e.g., via an API gateway, etc.) and the ticket creation system will generate and provide the created ticket to the centralized system 300. In some embodiments, the assignee is pre-assigned by the centralized system 300 (e.g., based on the status, topic category, sentiment category, service type, and/or location). In some embodiments, the assignee is manually assigned by the system user who creates or is creating the ticket. In another example embodiment, the ticket may be assigned (e.g., by the system user, the centralized system, the ticket creation system) to an appropriate handler or system user after the ticket is created. In some embodiments, the involvement of the system user is not required. Once the centralized system determines that extracted information falls under, for example, a negative sentiment category, the centralized system may automatically create (e.g., with an internal or external ticket creation system) an appropriate ticket and forward the ticket to the appropriate handler or system user. In some embodiments, when the centralized system 300 detects that one system user is currently accessing the ticket creation GUI 700 for specific information (e.g., post A, comments B, etc.), the centralized system 300 will disable other system users from creating a ticket for the same information at the same time (e.g., lock the ticket creation features on the ticket creation GUI 700, disable the access of other system users to the ticket creation GUI 700, etc.), so as to avoid multiple tickets being created for the same objective. In some embodiments, before creating a ticket, the centralized system 300 will present a list of created ticket(s) associated with the information, so that the system user can review the associated ticket(s) before creating a new ticket. In some embodiments, after the system user triggers an interactive element for creating the ticket (e.g., by clicking on a “Create Ticket” button), the centralized system 300 checks whether or not a ticket with the same parameters (e.g., status, topic category, sentiment category, service type, location, and/or Assignee) has already created for the same information, and present a notification (e.g., “Ticket with the same parameters have been created for this post”, etc.) to notify the system user before actually creating a new ticket based on the parameters selected by the system user.

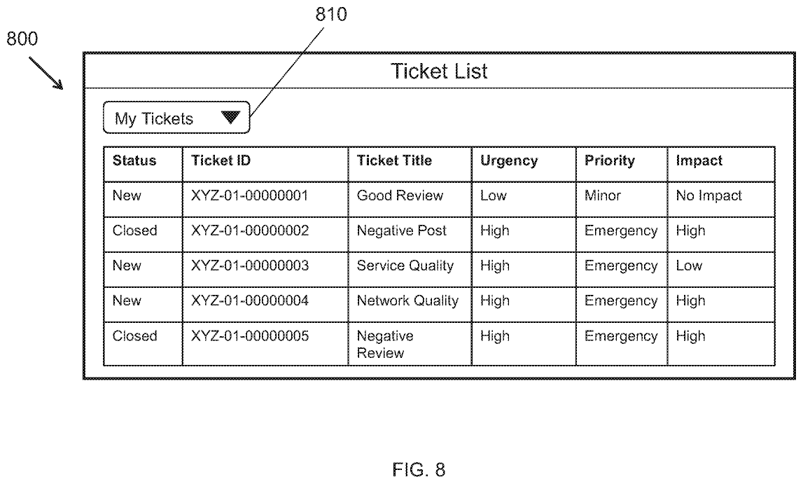

FIG. 8 is an example GUI illustrating the list of created tickets (hereafter “ticket list 800”), according to an embodiment.

The ticket list 800 is a list of all previously and newly created tickets. Each ticket in the ticket list 800 will include associated parameters including, but not limited to, ticket status, ticket ID, ticket title, urgency, priority, impact, ticket family (not depicted), domain (not depicted), and other suitable parameters for providing a summary of the ticket to the system user or the assignee. The new ticket created (via the ticket creation GUI 700) may be displayed at the top of the ticket list 800 with other previously created tickets following in the list (i.e., tickets are displayed in order of most recently created). In another example embodiment, the tickets may be displayed in order of urgency, priority, impact, topic category, or the like. Ticket parameters, such as urgency, priority, and impact, may be determined by the centralized system 300 based on, for example, the sentiment value/level and/or the topic category of the extracted information.

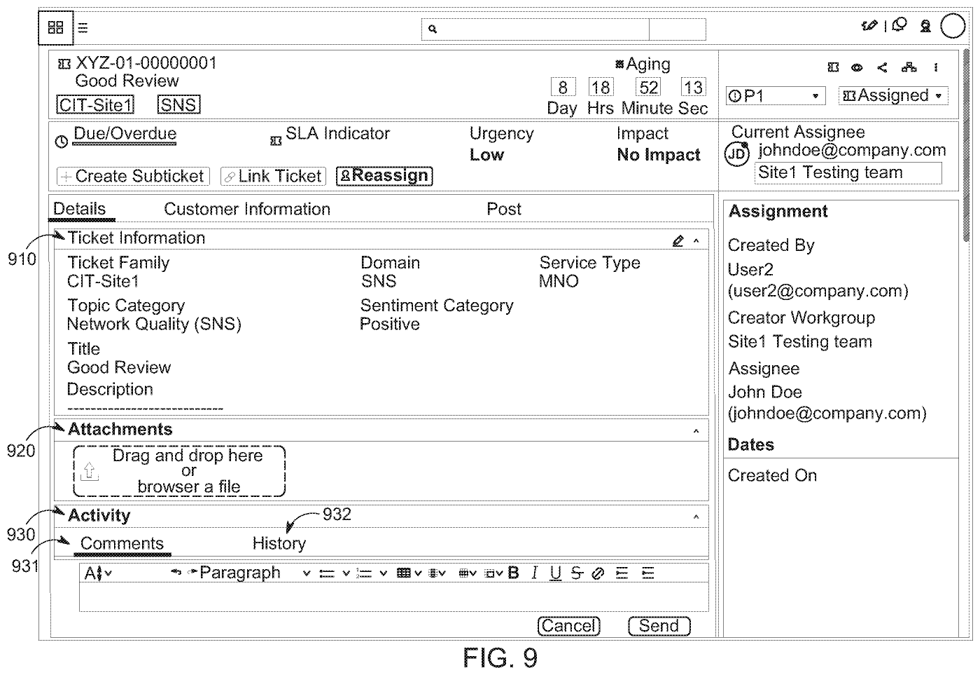

In some embodiments, the ticket list 800 also includes an assignee selection field 810. The system user may use this field to filter through all tickets based on assignee. In the example of FIG. 8, the ticket list is a view of tickets only assigned to the current system user. One or more of the ticket parameters may also include hyperlinks that, when selected, display or present (e.g., as a pop-up, new window/GUI, etc.) more detailed information relating to the ticket. An example of this will be described with reference to FIGS. 9-11.

FIG. 9 is an example GUI of a ticket details view 900 which is displayed when the system user selects one of the tickets in the ticket list 800 by, for example, clicking on the ticket ID. The ticket information (e.g., from the ticket list) indicating the selected ticket is presented at the top of the ticket details view 900. In another example embodiment, the ticket details view 900 may allow the system user to create a sub-ticket, link a ticket to a previously created ticket, or reassign the ticket. The system user is also able to view the assignee, information such as when the ticket was created, who the ticket was created by, creator workgroup, etc. The ticket details view 900 also includes tabs for performing different functions and viewing different types of information. For example, a details tab, a customer information tab, and a post tab. Embodiments are not limited to this. One or more additional tabs for performing other functions or viewing other information may be present. Additionally, one or more of the tabs described may not be present or other variations of those tabs may be present.

In some embodiments, the ticket details view 900 may also include an assignment summary. The assignment summary may include user information of the system user who created the ticket, user information of the current assignee, the workgroup related to the ticket or ticket creator, or the link.

FIG. 9 illustrates the details tab of the ticket details view 900. The details tab includes ticket information section 910, attachments section 920, and activity section 930. The ticket information section 910 may include, for example, information from the related information section 720 and/or the ticket list 800. Ticket information section 910 may also present a quick summary of the ticket and its respective post. The attachments section 920 may be used to add or insert attachments relating to the respective ticket by the system user, the assignee, any other personal with authority to view and edit the ticket. The activity section 930 provides the system user with a comments section 931 and history section 932 (e.g., illustrated in tab form in FIG. 9). The comments section 931 can be used by the system user to input notes or comments relating to the respective ticket. The comments section 931 may be viewed by other system users and provides all system users with a designated location to view relevant comments or provide feedback. The comments may be general comments for all to view regarding the ticket or may be comments directed to a specific system user (e.g., the assignee). The history section 932 may include a full activity history log relating to the respective ticket. For example, this may include prior communications between the system user/assignee and the end user, ticket reassignments, comment/post updates, etc. In another example embodiment, the details tab may also include a personal notes section where the comments posted are not viewable by other system users and only viewable and edited by the current system user. In another example embodiment, the personal notes section is only present when the current system user is the assignee of the currently selected ticket. The details tab is not limited to this configuration and other related information (e.g., external links) may be included.

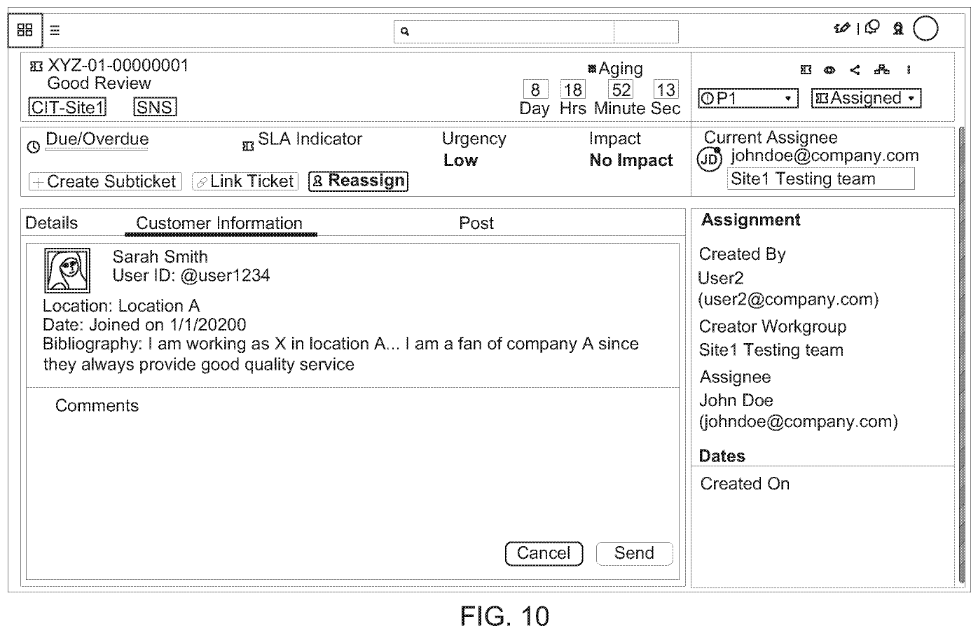

FIG. 10 illustrates the customer information tab of the ticket details view 900. The customer information tab may include end user information such as the end user's name, user ID, photo ID, location, email, phone number, social following, friends list, followers, user's joined date (i.e., when the user started to use the social platform), account bibliography (a portion of self-introduction presented on the user's page in the social platform), date the ticket was created, etc. Any and/or all contact information and social platform account information for the end user retrieved (e.g., from the social platform) may be displayed therein. As shown in FIG. 10, the end user who made the post relating to this ticket is Sarah Smith and all relating information (e.g., from the end user's social platform account) is displayed as well. The customer information tab may also include a portion wherein the assignee can insert comments on regarding the customer information, the customer, etc. For example, “This user is a subscriber of mobile plan A”.

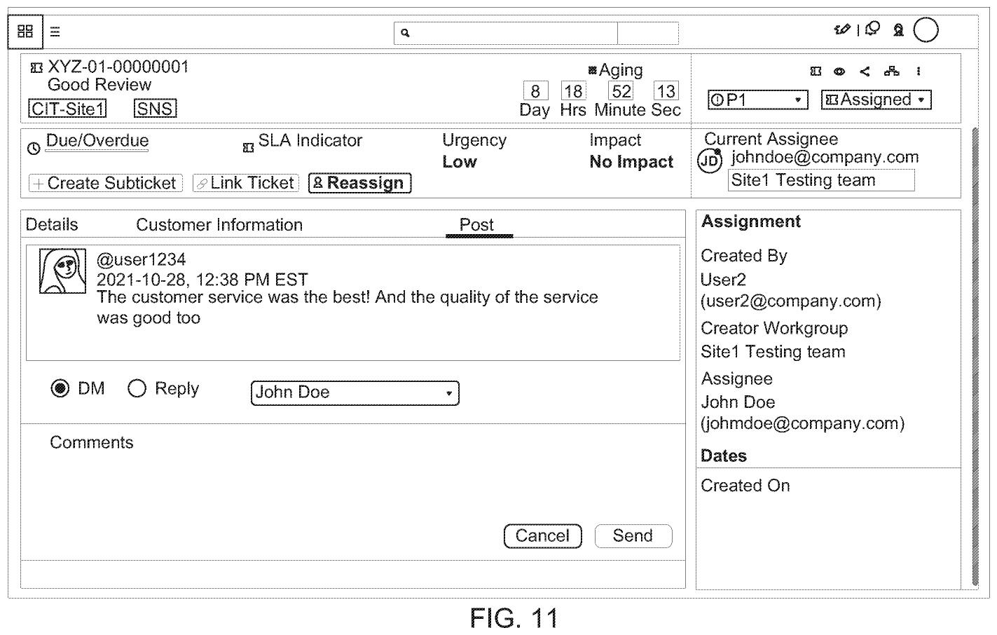

FIG. 11 illustrates the post tab of the ticket details view 900. The post tab view presents the system user with, for example, the contents of the post associated with the respective ticket. Other information (e.g., from the list 730 and/or from the listing of the post in the list of extracted information 630) may also be included. In some embodiments, the post tab includes a hyperlink (i.e., an external link) to the post to be viewed on the web and/or the social platform. Some embodiments may also include the ability to view one or more of the end user information from the customer information tab by performing a predetermined operation such as, for example, hovering over the post and/or username. Based on the details tab of the ticket (and/or other information on the ticket, post, customer information, etc.), the system user will determine whether or not it is required to interact with the end user who made the post (i.e., raised the information). If it is determined that it is required to do so, the system user may communicate with the end user through the post tab. Therein, the system user may select and/or fill out a message sender/sending address. In some embodiments, the system user can choose to send the message with his personal account (e.g., “John Doe” as illustrated in FIG. 11) or with an official account of the company/service provider (e.g., Service Provider A, etc.), Further, the system user may select and/or fill out the message contents, message type (e.g. direct message, reply to post, email, etc.), and the like in the post tab. As shown in FIG. 11, the system user/assignee (i.e., John Doe) will be communicating with the end user (i.e., Sarah Smith) via direct message (DM). The contents of the message from the system user to the end user is written/typed in the comments box. In some embodiments, once the system user triggers an interactive element to send the message (e.g., by clicking the “Send” button), the centralized system 300 will determine (e.g., based on the customer information, etc.) the source of the information (e.g., from which social platform the information is retracted, whether the social platform is accessed via webpage or via an application installed on the user terminal of the end user, etc.) and determine (e.g., based on the customer information and the determined source, etc.) an appropriate channel for sending the message to the end user (e.g., send a direct message to the end user via a chat application associated with social platform A from which the information was retracted, convert the message to SMS and send the SMS to the user terminal of the end user, etc.). By doing so, the system user may communicate with the end user without knowing which specific social platform the end user is using and/or which channel is the most appropriate/effective for sending the message. In some embodiments, the message may be viewed by the end user in their DM through the social platform. If the system user chooses to reply to the post, instead of communicating via DM, the end user will view the message as a reply to their post. In some embodiments, once the system user sends the message, the system user views the message (along with any other sent/received communication regarding the ticket) in a communication log included in the post tab. In some embodiments, once the system user sends the message, a notification will appear (e.g., as a pop up message, or the like) confirming that the DM (and reply or email) has successfully been sent.

Although FIGS. 6-11 show examples of GUIs, in some implementations, the GUI may include additional items, fewer items, different items, or differently arranged items than those depicted in FIGS. 6-11. Additionally, or alternatively, the operation and/or functionality of two or more of the items of the GUIs may be combined or different from the above detailed description. The GUIs illustrated in FIGS. 6-11 may be displayed to the system user via the device 200 or the like.

Advantages of the present disclosure include providing a system which can be used to quickly provide a response to end user's query/issue and standardize the classification of problematic information. This in turns improves the accuracy and efficiency of ticket creation.

The foregoing disclosure provides illustrations and descriptions, but is not intended to be exhaustive or to limit the implementations to the precise form disclosed. Modifications and variations are possible in light of the above disclosure or may be acquired from practice of the implementations.

Some embodiments may relate to a system including at least one memory configured to store computer program code and at least one processor configured to access the computer program code and operate as instructed by the computer program code, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, software instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer readable media according to various embodiments. In this regard, each block in the block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the figures. In some alternative implementations, the functions noted in the blocks may occur out of the order noted in the figures. For example, two blocks shown in succession may, in fact, be executed concurrently or substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts or carry out combinations of special purpose hardware and computer instructions.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing information from a social platform, the method comprising:
monitoring information on a social platform, based on predetermined keywords defined by a system user;
extracting information related to a service from the social platform, the extracted information containing one or more of the predetermined keywords;
determining a sentiment value associated with the extracted information;
assigning the extracted information to a sentiment category, the sentiment category being one of a positive sentiment category, a negative sentiment category, or a neutral sentiment category, based on the sentiment value; and
generating a graphical user interface (GUI) displayed to the system user, and
wherein the system user inputs information, based on the extracted information and the assigned sentiment category, to generate a ticket.

2. The method of claim 1, further comprising:
determining the sentiment value of the extracted information as a summation of a positive sentiment value and a negative sentiment value associated with each of one or more words included in the extracted information, based on one or more keyword files,
wherein the one or more keyword files contain:
a set of negative keywords associated with a negative sentiment and a predefined negative sentiment value associated with each keyword in the set of negative keywords;
a set of positive keywords associated with a positive sentiment and a predefined positive sentiment value associated with each keyword in the set of positive keywords; and
wherein when the summation is a negative value, the extracted information is assigned to the negative sentiment category, and when the summation is a positive value, the extracted information is assigned to the positive sentiment category, and when the summation has a value of zero, the extracted information is assigned to the neutral sentiment category.

3. The method of claim 2, wherein the predetermined keywords are included in the one or more keyword files and the one or more keyword files are defined by the system user.

4. The method of claim 1, further comprising:
generating a communication GUI, after the ticket is generated, wherein the system user communicates with an end user through the GUI to be viewed by the end user on the social platform,
wherein the system user selects communication via direct message, reply, or email.

5. The method of claim 1, wherein the predetermined keywords are keywords to be excluded from the extracted information.

6. The method of claim 1, further comprising comparing the extracted information to the predetermined keywords, based on a degree of similarity,
wherein the degree of similarity is determined by a machine learning model or by the system user.

7. The method of claim 1, further comprising:
generating a GUI containing a list of previously created tickets including ticket parameters assigned based on the extracted information and the assigned sentiment category, the ticket parameters being at least one or more of a ticket status, ticket title, ticket urgency, ticket impact, and ticket priority, and
wherein one or more of the ticket parameters are changeable by the system user via the GUI containing the list of previously created tickets.

8. The method of claim 7, wherein the ticket urgency and ticket impact are recommended and automatically filled by the system.

9. The method of claim 1, wherein the ticket is automatically created when the extracted information is assigned to the negative sentiment category, the neutral sentiment category, or the positive sentiment category.

10. The method of claim 1, wherein a plurality of social platforms are simultaneously monitored for the predetermined keywords to be extracted.

11. A system for processing information from a social platform, the system comprising:
at least one memory storing instructions; and
at least one processor configured to execute the instructions to:
monitor information on a social platform, based on a predetermined keywords defined by a system user;
extract information related to a service from the social platform, the extracted information containing one or more of the predetermined keywords;
determine a sentiment value associated with the extracted information;
assign the extracted information to a sentiment category, the sentiment category being one of a positive sentiment category, a negative sentiment category, or a neutral sentiment category, based on the sentiment value; and
generating a graphical user interface (GUI) displayed to the system user, and
wherein the system user inputs information, based on the extracted information and the assigned sentiment category, to generate a ticket.

12. The system of claim 11, wherein the processor is further configured to execute the instructions to:
determine the sentiment value of the extracted information as a summation of a positive sentiment value and a negative sentiment value associated with each of a one or more words included in the extracted information, based on one or more keyword files,
wherein the one or more keyword files contain:
a set of negative keywords associated with a negative sentiment and a predefined negative sentiment value associated with each keyword in the set of negative keywords;
a set of positive keywords associated with a positive sentiment and a predefined positive sentiment value associated with each keyword in the set of positive keywords; and
wherein when the summation is a negative value, the extracted information is assigned to the negative sentiment category, and when the summation is a positive value, the extracted information is assigned to the positive sentiment category, and when the summation has a value of zero, the extracted information is assigned to the neutral sentiment category.

13. The system of claim 12, wherein the predetermined keywords are included in the one or more keyword files and the one or more keyword files are defined by the system user.

14. The system of claim 11, wherein the processor is further configured to execute the instructions to:
generating a communication GUI, after the ticket is generated, wherein the system user communicates with an end user through the GUI to be viewed by the end user on the social platform,
wherein the system user selects communication via direct message, reply, or email.

15. The system of claim 11, wherein the processor is further configured to execute the instructions to compare the extracted information to the one or more predetermined keywords, based on a degree of similarity,
wherein the degree of similarity is determined by a machine learning model or by the system user.

16. The system of claim 11, wherein the processor is further configured to execute the instructions to:
generate GUI containing a list of previously created tickets including ticket parameters assigned based on the extracted information and the assigned sentiment category, the ticket parameters being at least one or more of a ticket status, ticket title, ticket urgency, ticket impact, and ticket priority; and
wherein one or more of the ticket parameters are changeable by the system user via the GUI containing the list of previously created tickets.

17. The system of claim 11, wherein the ticket is automatically created when the extracted information is assigned to the negative sentiment category, the neutral sentiment category, or the positive sentiment category.

18. The system of claim 11, wherein a plurality of social platforms are simultaneously monitored for the predetermined keywords to be extracted.

19. A non-transitory computer-readable storage medium for processing information from a social platform, the storage medium connected to one or more processors and configured to store instructions that, when executed, cause the at least one or more processors to:
monitor information on a social platform, based on a predetermined keywords set by a system user;
extract information related to a service from the social platform, the extracted information containing one or more of the predetermined keywords;
determine a sentiment value associated with the extracted information;
assign the extracted information to a sentiment category, the sentiment category being one of a positive sentiment category, a negative sentiment category, or a neutral sentiment category, based on the sentiment value; and
generating a graphical user interface (GUI) displayed to the system user, and
wherein the system user inputs information, based on the extracted information and the assigned sentiment category, to generate a ticket.

20. The non-transitory storage medium of claim 19, wherein the instructions, when executed, cause the at least one or more processors to:
determine the sentiment value of the extracted information as a summation of a positive sentiment value and a negative sentiment value associated with each of a one or more words included in the extracted information, based on one or more keyword files,
wherein the one or more keyword files contain:
a set of negative keywords associated with a negative sentiment and a predefined negative sentiment value associated with each keyword in the set of negative keywords;
a set of positive keywords associated with a positive sentiment and a predefined positive sentiment value associated with each keyword in the set of positive keywords; and
wherein when the summation is a negative value, the extracted information is assigned to the negative sentiment category, and when the summation is a positive value, the extracted information is assigned to the positive sentiment category, and when the summation has a value of zero, the extracted information is assigned to the neutral sentiment category.
